(19) United States
(12) Patent Application Publication
(10) Pub. No.: US 2026/0219422 A1
(43) Pub. Date: Jul. 30, 2026

(54) AN OPTICAL METASURFACE AND A METHOD FOR PRODUCING AN OPTICAL METASURFACE

(71) Applicant: Danmarks Tekniske Universitet, Kongens Lyngby (DK)

(72) Inventors: Anders KRISTENSEN, Kongens Lyngby (DK); Airidas ZUKAUSKAS, Kongens Lyngby (DK); Murat SERHATLIOGLU, Kongens Lyngby (DK); Kristoffer SKAFTVED, Kongens Lyngby (DK); Andreas Raimund STILLING-ANDERSEN, Kongens Lyngby (DK); Mahmoud TAWFIEQ, Kongens Lyngby (DK); Zhengli HAN, Kongens Lyngby (DK)

(21) Appl. No.: 19/158,215

(22) PCT Filed: Feb. 21, 2024
(86) PCT No.: PCT/EP2024/054443

§ 371 Date: Aug. 20, 2025

(30) Foreign Application Priority Data
Feb. 22, 2023 (EP) 23158052.3

(51) Int. Cl. G02B 1/00

(52) U.S. Cl. CPC G02B 1/002; G02B 2207/101

(57) ABSTRACT

An optical metasurface to interact with incoming light and a method for producing an optical metasurface are provided. The optical metasurface may be used as a meta-lens, a blazed grating, a phase plate or another optical device. The optical metasurface includes a transparent substrate comprising a plurality of nano-holes or nano-pillars. The plurality of the nano-holes or nano-pillars of the transparent substrate are covered by a plurality of shaped layers comprising a transparent dielectric material.

### FIELD OF THE INVENTION

The present invention relates to an optical metasurface to interact with incoming light and a method for producing an optical metasurface. The optical metasurface may be used as a meta-lens, a blazed grating, a phase plate, a hologram or other optical devices.

### BACKGROUND OF THE INVENTION

Metasurfaces have the ability to manipulate light fields. Metasurfaces comprise nano-scale/sub-wavelength size structures, which may be used to control the amplitude, phase, and polarization of light through sub-wavelength units, compared with the traditional lens that relies on the modulated light beam. Metasurfaces may be used for lenses, blazed gratings, phase plates, holograms or other optical devices.

Classical optical devices, for instance ophthalmic lenses, which for instance may be used for glasses, are controlling the path of light via optical refraction by engineering the shape and thickness of a piece of transparent material. They rely on light propagating inside the lens material over distances much larger than the wavelength to accumulate the required change in phase for the desired optical functionality. This dictates how thin the optical device or lens can be. The same problem exists of blazed gratings and other optical devices. The thickness and weight of high power lenses and other optical devices remain an unsolved nuisance.

Metasurfaces are thin and light weight, and meta-lenses and other optical devices can be made considerable lighter and thinner than classical optical devices. However, making effective optical components, e.g. lenses, able to obtain the required optical properties and quality using metasurfaces have not been as successful in the past as desired. Fabrication of metasurfaces has not been possible in a cost-efficient and upscalable way.

Hence, an improved optical metasurface suitable for design and manufacture by cost-efficient means would be advantageous, and in particular an optical metasurface device suitable for mass-customisation would be advantageous.

### OBJECT OF THE INVENTION

It is an object of the present invention to provide an optical metasurface with high optical performance.

It is an object of the present invention to provide an optical metasurface for glasses and other optical devices applying nano-photonic metasurface flat optics for the meta-lenses.

It is a further object of the present invention to provide an alternative to the prior art.

In particular, it may be seen as an object of the present invention to provide an optical metasurface that solves the above mentioned problems of the prior art.

### SUMMARY OF THE INVENTION

Thus, the above described object and several other objects are intended to be obtained in a first aspect of the invention by providing an optical metasurface to interact with incoming light, wherein the metasurface is comprising
a transparent substrate comprising a plurality of nano-holes or nano-pillars, wherein the nano-holes or nano-pillars have vertical or substantially vertical side walls extending perpendicular to a base plane of the substrate, and
a plurality of shaped layers comprising a transparent dielectric material, wherein each shaped layer covers a plurality of the nano-holes or the nano-pillars of the transparent substrate.

An optical metasurface comprises a transparent substrate whereon there is deposited a transparent dielectric material. The transparent substrate comprises topographical features in the form of a plurality of nano-holes or nano-pillars. The transparent dielectric material is forming high-index dielectric structures, which are a plurality of shaped layers on the substrate.

The invention applies nano-photonics, metasurface flat optics and micro-fabrication to create optical metasurfaces.

That the substrate and the dielectric material is transparent allows light to pass through the optical metasurface and therefore the optical metasurface of the invention is particular suitable for meta-lenses which may be used in spectacles by a person to improve sight. It may also be used in other optical devices requiring light to pass through a lens.

Nano-photonics and metasurface flat optics are directly related to the fundamental understanding of optics, established by Isaac Newton in the late 17^{th} century that light is carrier of information—frequency dependent amplitude (colour), phase, polarization—which is coded into the electromagnetic field of light when it interacts with materials. Modern microfabrication technologies are used to create artificial, fabricated materials with engineered optical properties—offering new avenues to code information into light, without being constrained by the electromagnetic response of natural materials and their chemical compounds.

The base plane is the plane corresponding to the plane of the substrate surface between the nano-pillars or nano-holes of the substrate.

A “shaped layer” is to be understood as a uniform layer covering a plurality of nano-holes or nano-pillars.

According to an embodiment, the distance between two neighbouring nano-holes or nano-pillars is less than half the wavelength of the incoming light, where the incoming light can be ultra-violet light, visible light, near infrared light and/or infrared light.

The distance between two neighbouring nano-holes of nano-pillars are less than the wavelength of the incoming light. The effect of this is to minimize or even avoid unintended scattering of light.

Ultra-violet light has a wavelength of 10-400 nm, visible light has a wavelength of 400-700 nm, near infrared light has a wavelength of 700-1400 nm, while infrared light has a wavelength from 700 nm and up to 1 mm. Therefore, the selection of the distance between two nano-holes or nano-pillers will highly depend on what kind of light the optical metasurface is intended to receive.

The nano-holes or nano-pillars may be placed equidistanced on the substrate, meaning that the nano-holes or nano-pillars is placed in a uniform pattern, where the distance between two neighbouring nano-holes or nano-pillars are equal all over the substrate.

However, alternatively the nano-holes or nano-pillars may not be placed equidistanced, but instead be placed in other patterns or even placed randomly, but the distance between two neighbouring nano-holes or nano-pillars is less than the wavelength of the incoming light.

The plurality of nano-holes or nano-pillars may be identical. Being identical is to be understood as the plurality of nano-holes or nano-pillars comprises the same height and diameter.

The distance between two neighbouring nano-holes or nano-pillars is measured from the centre of one nano-hole or nano-pillar to the centre of the neighbouring nano-hole or nano-pillar.

According to an embodiment, the optical metasurface is a truncated waveguide metasurface comprising a two-dimensional array of meta-atoms, where each meta-atom comprises one nano-hole or nano-pillar.

Optical metasurfaces are two-dimensional arrays of nanoscale elements, called meta-atoms. The meta-atoms act as individual nanoscale optical antennas, which—via their size and shape—at the nano-scale offer full control of light (frequency dependent amplitude, phase and polarization) as it interacts with the metasurface—for example, when light is transmitted through the surface. In contrast to conventional lens technology described above, optical metasurfaces can provide a required change to the optical field—amplitude, phase, polarization—abruptly, as it propagates over distances on the scale of the wavelength of light—less than a μm. This is used to create ultra-thin, so-called metasurface flat optics, including broadband achromatic meta-lenses. In flat optics meta-lenses, the size, shape and morphology of the meta-atoms are varied across the surface area to obtain the variation of phase change required for the desired optical function.

The invention concerns cost-efficient mass customization of so-called truncated waveguide metasurfaces. A truncated waveguide relies on field confinement in nanostructures for which the dimensions of the structures can be used to tune the propagation constant. A change in propagation constant compared to neighbouring meta-atoms will directly translate to a phase shift.

Metamaterials are artificial structures with unusual and superior properties that come from their carefully designed building blocks—also called meta-atoms. Metamaterials have permeated large swatches of science, including electromagnetics and mechanics.

This invention is a cost-efficient method for mass fabrication of individualized optical meta-surfaces, which can be applied for ultra-thin so-called flat optical components (e.g., lenses, gratings and phase plates)—with potential to disrupt the 100 B€ market for ophthalmic lenses by introducing the world's thinnest prescription lenses. Further, the invention may also be exploited for optical sensors and ink-free colour decoration (structural colours).

A meta-lens is a type of flat lens that is made of a thin metal film, typically a few hundred nanometres thick, deposited on a substrate. Unlike traditional lenses, which are made of glass or plastic and have curved surfaces to refract light, meta-lenses use nanoscale patterns on their surface to manipulate light in a similar way. This allows them to be much smaller, lighter, and more versatile than conventional lenses. Meta-lenses have potential applications in a range of fields, including optics, microscopy, and consumer electronics. Meta-lenses are a flat lens technology made by optical components that use metasurfaces to focus light. They can be used in optical applications that take advantage of the flat surface and reduced thickness, compared to classic, curved refractive lenses mainly used in optical devices today.

The invention is particularly, but not exclusively, advantageous for obtaining lightweight optical devices and optical devices with high optical performance.

“Covers a plurality of the nano-holes or nano-pillars” is to be understood that the transparent dielectric material covers the substrate so the plurality of nano-holes or nano-pillars are covered by covering the bottom of the nano-holes and the top of the nano-pillars as well as the walls of the nano-holes or nano-pillars.

It is noted that optical properties of the high-index dielectric structures formed by the transparent dielectric material may be relevant for transmission and/or reflection. For example, if a reflected colour can be seen on top of a surface, another transmitted colour may be seen on the other surface.

In embodiments, the relative permittivity at 532 nm of the high-index dielectric structures formed by the transparent dielectric material is equal to or larger than 5, such as equal to or larger than 6, such as equal to or larger than 7, such as equal to or larger than 8, such as equal to or larger than 9, such as equal to or larger than 10.

In the present context ‘optical’ may be understood as relating to within the visible electromagnetic spectrum.

The plurality of shaped layers are high-index dielectric structures comprising a transparent dielectric material.

By ‘high-index dielectric structures’ may be understood structures (e.g., high-index dielectric nanoparticles, nano-holes in a high-index dielectric material, etc.). They may be able to couple with electromagnetic radiation of wavelengths that are larger, such as far larger, than the structures due to resonances. It may be understood that high-index dielectric structures may correspond to a plurality of similar high-index dielectric structures, such as periodically arranged structures, which may optionally each correspond to a plurality of structures (such as a disk and a nano-hole) where the high-index dielectric structures may be divided into unit cells.

It may be understood that the high-index dielectric structures may exhibit a resonance in the visible regime. The resonance may be any one or more of a cavity resonance, an electric dipole resonance, a magnetic dipole resonance and/or a whispering gallery mode resonance.

The transparent substrate is a support structure, which may be understood a material supporting the high-index dielectric structures. It may be understood as a solid material whereupon the high-index dielectric structures are placed and/or wherein the high-index dielectric structures, such as each of the high-index dielectric structures within the first plurality of high-index dielectric structures, are embedded.

It is noted that polymer (while polymer may be seen as advantageous, e.g., for allowing topographical features to be provided by nanoimprint lithography) is not essential as choice of material for the transparent substrate, and could in an alternative embodiment be another material, such as glass. Examples of possible polymer materials include TOPAS (COC (cyclic olefin copolymer)), Poly(methyl methacrylate) (PMMA), polyethylene (PE), polystyrene (PS) and composite, or hybrid materials, such as Ormocers.

The transparent dielectric material on the transparent substrate may form a metasurface.

By ‘topographical features’ may be understood features on a surface of a material which deviates from the plane of the surface. For example, protrusions and indentations, such as nano-pillars and nano-holes.

Topographical features in the transparent substrate may be beneficial for enabling or facilitating providing high-index dielectric structures. For example, if the transparent substrate comprises a plurality of nano-pillars protruding from the surface, then the transparent dielectric material may be directly provided by depositing a high-index dielectric film on the transparent substrate.

By ‘pillars’ may be understood protrusions, such as protrusions of a substantially cylindrical shape protruding from a surface.

By ‘holes’ may be understood indentations, such as indentations of a substantially cylindrical shape into a surface.

The metasurfaces of the invention may be used in the visible regime. By the visible regime may be understood electromagnetic radiation (which in this regime may be referred to as ‘light’) with a wavelength between 380 nm and 760 nm.

The metasurfaces of the invention may alternatively be for ultraviolet, near infrared, infrared and/or far infrared radiation.

The invention adds optical functionality to nanostructured dielectric substrates by one or several overlaid patterned depositions of material.

This is different to other meta-surface fabrication methods, where nano-scale/sub-wavelength meta-atoms are individualized by:
electron-beam or Deep-Ultraviolet lithography of each meta-surface component,
electron-beam or Deep-Ultraviolet lithography of replication master, e.g. nano-imprint stamp,
laser machining on metasurfaces using heat from the laser beam. Laser machining uses thermal energy to remove material from metallic or non-metallic surfaces. The high intensity of monochromatic light will fall on the surface, thus heating, melting and vaporizing the material due to the impinge of photons, and
focused ion beam deposition.

The high intensity of monochromatic light used to laser machining depends on the material the meta-atoms are made of. For optical components the material is chosen so that it is transparent in the windows in which the component must work. E.g. TiO₂ is used for components in the visible range, and here the laser is chosen with a wavelength that is absorbed by TiO₂—i.e. wavelengths below 400 nm. 355 nm was used in experiments. Preferable intensities up to 4.5 J/cm² may be used, but it is possible to use intensities up to 10 J/cm². Pulsed lasers may be used. In experiments pulse lasers was used with a pulse length of about 1 ns and a repetition rate of 100 Hz to write with. Pulsed lasers may have repetition rates up to several MHz (10 MHz or higher)—it is the repetition rate that determines the write time for a given area.

In the invention described in this description, the local modification of optical properties, like transmission, reflection and phase change, is controlled via the optical properties, like dielectric constant, refractive index and thickness of deposited layer of material. The sub-wavelength/nano-scale features of the meta-atom that govern it's interaction with light-scattering, phase-propagation, polarization—is defined partly by the nano-hole geometry, partly by the material parameters and thickness of the deposited material.

The invention enables high volume fabrication of individualized optical metasurface components, where cost-efficient UV lithography creates the required variations in initially identical meta-atoms/nano-structures. The UV lithography may be maskless UV lithography, but other types of UV lithography would work just as well.

According to an embodiment, two neighbouring shaped layers are of a different thickness, which results in a different phase shift of the incoming light.

The thickness of the shaped layers is determining the phase shift of the incoming light passing through the shaped layers. Therefore, different shaped layers of different thickness having different phase shifts and thereby different phase levels.

A phase level is to be understood as areas where the phase shift is substantially the same. Different separated areas may have the same phase level. Therefore, a metasurface may have a plurality of shaped layers, but only a few phase levels as two, or more, of the shaped layers may have the same phase level.

An optical metasurface comprises two or more phase levels. A phase level is relating to the thickness of the layer of transparent dielectric material. The number of phase levels depends on the deposition technique used for depositing the transparent dielectric material on the substrate. The phase shift of the incoming light depends on the thickness of the transparent dielectric material and therefore different phase shift is obtained for each phase level of the transparent dielectric material. The more phase levels the metasurface comprises the more efficient an optical device formed by the metasurface will be.

According to an embodiment, the nano-holes or nano-pillars comprises a sidewall and a bottom or top, and the transparent dielectric material is deposited on the sidewalls and on the bottom or top, forming a dielectric cylinder.

The transparent dielectric material is deposited on the sidewall of the nano-holes or nano-pillars and on the bottom of the nano-holes or the top of the nano-pillars.

The transparent dielectric material deposited in a nano-hole or deposited around a nano-pillar, is forming a dielectric cylinder comprising a nano-tube in the dielectric cylinder. It is in the dielectric cylinder that the phase change of incoming light is controlled by the height, diameter and the thickness of the sidewalls of the dielectric cylinder.

The nano-tube is the sidewalls of the dielectric cylinder where between there is a hollow core.

Further, the transparent dielectric material is deposited on the flat surface of the metasurface between the nano-pillars or nano-holes.

According to an embodiment, the plurality of shaped layers are ring shaped, and each shaped layer is uninterrupted along the ring shape.

That the “plurality of shaped layers are ring shaped” is to be understood as each layer around the centre forms a closed loop; the closed loop may be a circle, an ellipse or any other form creating a closed loop similar to a circle or an ellipse but not necessarily an exact circle or ellipse. Further, the innermost layer may form a disc covering the centre.

The ring formed shaped layers may be wider close to the centre and then may become smaller further away from the centre.

According to an embodiment, the optical metasurface comprises a plurality of Fresnel rings forming a Fresnel metasurface meta-lens, each Fresnel ring comprises two, or more, shaped layers with different thickness.

For instance, each Fresnel ring may comprise two, or more, shaped layers with different thickness. By having different thickness, the shaped layers belong to different phase levels.

According to an embodiment, the plurality of shaped layers are forming a concentric annular closed loop, preferable a circle or an ellipse.

The shaped layers may be annular, meaning that the layers are shaped like a ring or a series of concentric rings placed around the centre.

Each Fresnel ring comprises two or more shaped layers, and each shaped layer are concentric placed around the centre. Each shaped layer preferable comprises a uniform thickness to obtain the same phase-shift for the entire shaped layer. Each ring formed shaped layer may be elliptical or circular.

There may for instance be four shaped layers in a Fresnel ring, the layers may for instance have a thickness of 0 nm, 33 nm, 66 nm, and 99 nm respectively.

The centre may be covered by a disc of dielectric material. The innermost shaped layer may form a disc covering the centre. All other shaped layers are placed around the innermost shaped layer. Note that a shaped layer may have a thickness of 0 nm. Therefore, the centre may just be the bare substrate.

The Fresnel rings forms a Fresnel metasurface meta-lens, which is a lens corresponding to a Fresnel lens. A Fresnel lens consists of a series of concentric ring formed sections that are much thinner than a conventional lens, reducing the amount of material required.

Classical ophthalmic lenses, which for instance may be used for glasses, are controlling the path of light via optical refraction by engineering the shape and thickness of a piece of transparent material. They rely on light propagating inside the lens material over distances much larger than the wavelength to accumulate the required change in phase for the desired optical functionality. This dictates how thin the lens can be.

The thickness and weight of high-power lenses remain an unsolved nuisance. This nuisance is related to the fact that today's lenses are made by engineering the shape and thickness of the transparent lens material for controlling refraction as described above.

Metasurfaces are thin and light weight and meta-lenses, and other optical devices can be made considerable lighter than classical ophthalmic lenses. However, making effective optical components, e.g. lenses, able to obtain the required optical properties and quality using metasurfaces have not been as successful in the past as desired.

Using a metasurface meta-lens as a Fresnel lens obtains a much lighter lens than used by conventional optics.

According to an embodiment, wherein the transparent dielectric material is a high index dielectric material, which has been selected from a list of TiO₂, AL₂O₃, Si, SiO₂, Ge, GaAs, InP, HfO₂, BaTiO₃, Pb[ZrₓTi₁₋ₓ]O₃, SrTiO₃, Ba₍₁₋ₓ₎SrₓTiO₃, PbTiO₃, CaTiO₃, MgO, ZrO₂.

In this application, Titanium dioxide (TiO₂) is the preferred material for the transparent dielectric material, and TiO₂ is used in the mentioned examples, but any high index dielectric material may be considered for the invention replacing TiO₂. These material may for example be aluminium oxide (AL₂O₃), Silicon (Si), Silicon dioxide (SiO₂), Germanium (Ge), Gallium arsenide (GaAs), Indium phosphide (InP), hafnium dioxide (HfO₂), Barium titanate (BaTiO₃), Lead zirconate titanate (Pb[ZrₓTi₁₋ₓ]O₃ (0≤x≤1)), Strontium titanate (SrTiO₃), Barium strontium titanate (Ba₍₁₋ₓ₎SrₓTiO₃ (0≤x≤1)), Lead titanate (PbTiO₃), Calcium titanate (CaTiO₃), Magnesium oxide (MgO), Zirconium dioxide (ZrO₂).

That the transparent dielectric material being a high-index dielectric material is to be understood that a high-index dielectric material is a type of material that has a high refractive index, meaning it bends light more than materials with a lower refractive index. Bending of light requires a gradient of phase shifts, corresponding to varying thickness of conventional wedges or prims. The higher index, the less material (thickness) is required. These materials are often used in optical devices, such as lenses, because they can reduce the size and weight of the device while still maintaining its optical performance.

A second aspect of the invention relates to an optical device comprising a metasurface, wherein the optical device has been selected from a list of a meta-lens, a blazed grating, a phase plate, a hologram, a vortex beam generator, a spatial light modulator, an optical switch.

A metasurface may be used for several different optical devices.

A blazed grating is a type of diffraction grating that consists of a surface with many closely spaced parallel lines. It is designed to diffract light in a specific direction, known as the “blaze direction,” and to maximize the diffraction efficiency for a particular wavelength or range of wavelengths. The blazed grating works by exploiting the principle of diffraction, where light is bent as it passes through the closely spaced lines of the grating. This bending of light causes it to interfere constructively in the blaze direction, resulting in high diffraction efficiency. Blazed gratings are used in a variety of applications, including spectroscopy, laser beam shaping, and optical communication systems.

A phase plate is a device that is used to manipulate the phase of light waves. A phase plate is used to change the phase of light by modifying its path length through a transparent material.

A hologram is a type of optical illusion that creates a three-dimensional image of an object by projecting laser light through a photographic plate or another medium that has recorded an interference pattern of the object's light. The optical metasurface of the invention may be used as such a medium.

A vortex beam generator is a device that produces a type of laser beam known as a vortex beam. A vortex beam is a beam of light that has a phase singularity, or a point where the phase of the light changes abruptly. A vortex beam generator typically uses a phase plate or other optical elements to impose the phase vortex onto a conventional laser beam, creating the vortex beam. The optical metasurface of the invention may be used as such an optical element.

A spatial light modulator is used to manipulate the phase and amplitude of a light beam. They can be used for applications such as beam shaping, holographic displays, and adaptive optics. The optical metasurface of the invention may be used as such a spatial light modulator.

A third aspect of the invention relates to a pair of spectacles comprising at least one meta-surface according to claim 1, wherein the shaped-layers are ring shaped.

The meta-surface may form a meta-lens. Two meta-lenses may be used for a pair of spectacles for use by a person. Each shaped layer preferably is uninterrupted along the ring shape.

The optical metasurfaces may form ultra-lightweight lenses for glasses to realize lenses as a thin nanostructured film (1 mm or less). The lenses are suited for lens manufacturing to realize cost-efficient mass customization of optical metasurfaces, where identical mass-produced nano-structured substrates are converted into individualized optical components by mask-less photolithography.

This aspect of the invention is particularly, but not exclusively, advantageous in that meta-lenses are considerable lighter than classical ophthalmic lenses and therefore a pair of spectacles comprising meta-lenses will be considerable lighter than a classical pair of spectacles.

A fourth aspect of the invention relates to a method for producing an optical metasurface for interacting with incoming light, wherein the method is comprising:
providing a transparent substrate comprising a plurality of nano-holes or nano-pillars, wherein the nano-holes or nano-pillars have vertical or substantially vertical side walls extending perpendicular to a base plane of the transparent substrate, and
covering at least a portion of the transparent substrate with shaped layers of a transparent dielectric material so that each shaped layer covers a plurality of the nano-holes or nano-pillars of the transparent substrate.

The transparent substrate is provided, the transparent substrate may be made in different ways, and it is not a part of the invention how transparent substrate is made.

The transparent substrate comprises a plurality of nano-holes or nano-pillars. A portion of the transparent substrate is covered by shaped layers of different thickness. A portion of the transparent substrate may not be covered at all.

This aspect of the invention is particularly, but not exclusively, advantageous in that the method according to the present invention may obtain lightweight optical devices and optical devices with high optical properties.

According to an embodiment, covering at least a portion of the transparent substrate with shaped layers of a transparent dielectric material comprises the steps:
a) covering the transparent substrate and/or previous deposited transparent dielectric material by a layer of photoresist,
b) exposing the photoresist with electromagnetic radiation, where the transparent dielectric material is to be placed in contact with the transparent substrate or the previous deposited transparent dielectric material, or where the transparent dielectric material is not to be placed in contact with the transparent substrate or the previous deposited transparent dielectric material,
c) removing either the photoresist, which has been exposed to electromagnetic radiation, or the photoresist, which has not been exposed to electromagnetic radiation,
d) covering at least a portion of the substrate and/or the previous deposited transparent dielectric material with a depositing layer of transparent dielectric material,
e) removing the remaining photoresist and hereby also removing transparent dielectric material deposited on the top of the photoresist, and
f) repeating the steps a)-e) a predetermined number of times.

A shaped layer may comprise 0, 1, 2, or more, depositing layers. The depositing layers may be of different thickness. Basically, the idea is to deposit different depositing layers of transparent dielectric material to form the shaped layers.

The lift-off process may use a positive tone photoresist, where areas of the photoresist radiated with electromagnetic radiation, preferable ultraviolet radiation, is removed, or a negative tone photoresist, where areas not radiated is removed.

The first time transparent dielectric material is deposited there are no previous deposited transparent dielectric material, so the layer of photoresist is placed on the transparent substrate. Then some of the transparent photoresist is radiated with electromagnetic radiation, and then either the radiated photoresist is removed, or the non-radiated photoresist is removed, whereby the desired pattern/shape of the transparent dielectric material to be deposited is transferred to the photo-resist.

After removal of some of the photoresist, transparent dielectric material is deposited. The deposited transparent dielectric material is covering both the photoresist and the substrate, where the photoresist was removed. Then the remaining photoresist is removed and with is the transparent dielectric material deposited on the top of the photoresist forming the first depositing layer.

If more than one depositing layer of transparent dielectric material is to be deposited the steps a)-e) is repeated. For each additional depositing layer of transparent dielectric material is to be deposited, first in step a) the transparent substrate and the previous deposited transparent dielectric material is covered by a layer of photoresist, then in step b) some of the photoresist is radiated by electromagnetic radiation. Then in step c), the radiated or the non-radiated photoresist is removed where the next depositing layer of transparent dielectric material is to be deposited. Then in step d) transparent dielectric material is deposited, and when in step e) when the remaining photoresist and hereby also the transparent dielectric material deposited on the top of the photoresist is removed, leaving the additional depositing layer of transparent dielectric material on top of the previous deposited transparent dielectric material and/or on top of the substrate. An additional depositing layer usually will cover some of the previous deposited transparent dielectric material and some of the substrate, where the substrate not have been covered before.

The steps a)-e) are repeated a preselected number of times to form the shaped layers with the required number of phase levels. For each time the steps a)-e) are repeated, the number of phase levels is increasing. If the process is only performed one time, the metasurface comprises two phase levels. If the process is repeated once, and thereby performed twice, the metasurface comprises four phase levels. If the process is performed three times, the metasurface comprises eight phase levels, if the process is performed four times; the metasurface comprises sixteen phase levels etc.

It is also possible to combine the different dielectric materials by using different transparent dielectric materials in step d) each time the process is performed.

The first deposited deposition layer typically will be the thickest layer. The second layer may be half the thickness of the first layer, and the third layer may be half the size of the second layer and so on, so by each repetition of depositing a deposition layer, the deposition layer is half the thickness of the previous deposition layer. Hereby the number of phase levels is doubled for each additional deposition layer.

In an alternative embodiment covering at least a portion of the transparent substrate with shaped layers of a transparent dielectric material, is obtained by depositing a layer of transparent dielectric material on the transparent substrate and then cut away some of the transparent dielectric material to obtain the shaped layers.

According to an embodiment covering at least a portion of the transparent substrate with shaped layers of a transparent dielectric material comprises the steps:
covering at least a portion of the transparent substrate with transparent dielectric material, and
geometrically modifying the transparent dielectric material on the transparent substrate by removing portions of the transparent dielectric material to form the shaped layers.

By ‘geometrically modifying’ may be understood modifying the geometry, whereby is understood shape, size, and/or relative position of the transparent dielectric material. It may be understood that the geometric modifications of the high-index dielectric structures may have an effect on their optical properties.

The layer of transparent dielectric material may be worked to remove part of the transparent dielectric material. This will increase the possibilities to modify a metasurface.

According to an embodiment the method further comprises
removing portions of the layer of the transparent dielectric material by laser ablation.

Laser ablation or photo ablation is the process of removing material from a solid (or occasionally liquid) surface by irradiating it with a laser beam. At low laser flux, the material is heated by the absorbed laser energy and evaporates or sublimates. At high laser flux, the material is typically converted to a plasma. Usually, laser ablation refers to removing material with a pulsed laser, but it is possible to ablate material with a continuous wave laser beam.

The described “high laser flux” and “low laser flux” regimes depend on the specific material of the meta-atom, and of the specific geometrical shape and size of the meta-atom, and of the specific laser wavelength relative to optical spectrum for the meta-atom material, and relative to optical resonances in the meta-atom.

Part of the transparent dielectric material may be removed by laser ablation.

Hereby a smoother surface may be obtained by removing the stepwise transition between the different phase levels, or by subdividing a phase level into additional phase levels.

The first, second, third and fourth aspect of the present invention may each be combined with any of the other aspects. These and other aspects of the invention will be apparent from and elucidated with reference to the embodiments described hereinafter.

### BRIEF DESCRIPTION OF THE FIGURES

The optical metasurface and the method for producing an optical metasurface according to the invention will now be described in more detail with regard to the accompanying figures. The figures show one way of implementing the present invention and is not to be construed as being limiting to other possible embodiments falling within the scope of the attached claim set.

FIG. 1 shows an optical metasurface according to the invention.

FIG. 2 shows the truncated waveguide metasurface architecture used in the invention.

FIG. 3 shows a cross-section of a meta-atom with a nano-hole.

FIG. 4 shows a cross-section of a meta-atom with a nano-pillar.

FIG. 5 shows an outline of process flow for cost-efficient fabrication of individualized optical Metasurfaces.

FIG. 6 shows generation of four phase levels by a two-step UV lithography lift-off process.

FIG. 7 shows an illustration of numerical simulations for metasurfaces design.

FIG. 8a shows an optical metasurface, a meta-lens, according to the invention comprising a plurality of ring formed shape layers.

FIG. 8b shows four ring formed shaped layers of a Fresnel ring.

FIG. 9a shows another optical metasurface, a blazed grating, according to the invention.

FIG. 9b shows the shaped layers of four different thicknesses of the metasurface of FIG. 9a.

FIG. 10a shows a simulated phase shift as a function of the TiO₂ thickness of the dielectric material, for different nano-hole diameters.

FIG. 10b shows a simulated phase shift as a function of the TiO₂ thickness t of the dielectric material, for different nano-hole depths h.

FIG. 11a shows a simulated phase shift as a function of the TiO₂ thickness of the dielectric material for different periods.

FIG. 11b shows a simulated phase shift as a function of the TiO₂ thickness for different ratios of the diameter and periods.

FIG. 12 shows (top left) a microscope image of 8 mm diameter diopter 15 binary phase Fresnel metasurface meta-lens, (top right) microscope image of 8 mm diameter diopter 2.5 binary phase Fresnel metasurface meta-lens and (bottom) diopter 15 lens focuses DTU logo.

FIG. 13 shows a phase lens design: (a) the required phase modulation profile for the meta-lens, (b) phase discretization and (c) theoretical lens efficiency as function of phase discretisation levels, N.

FIG. 14 shows SEM images of the first lift-off process on fused silica substrate.

FIG. 15 shows a SEM image of the second lift-off process on fused silica substrate.

FIG. 16 is a flow chart illustrating the main method of the invention.

FIG. 17 is a flow chart illustrating an alternative method of the invention.

### DETAILED DESCRIPTION OF AN EMBODIMENT

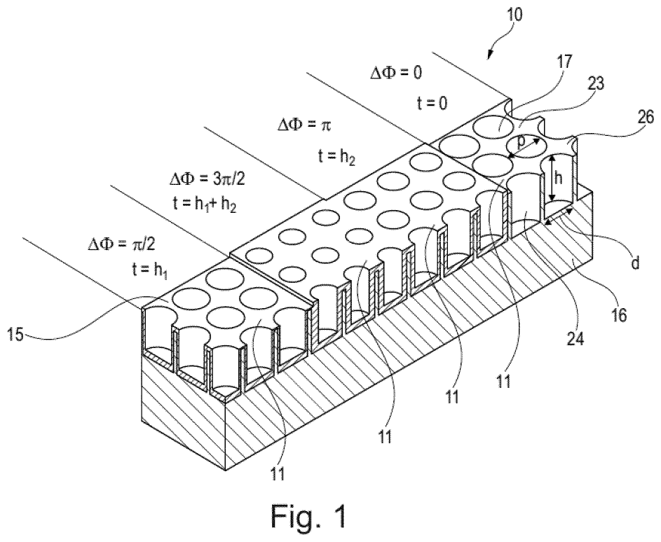

FIG. 1 shows an optical metasurface 10 according to the invention. The metasurface comprises a transparent substrate 16 comprising a plurality of equidistanced nano-holes 17. The nano-holes comprises sidewalls 24. The sidewalls are extending perpendicular to the base plane 23. The base plane 23 is corresponding to the surface of the substrate. A plurality of shaped layers 11 is deposited on the substrate.

In FIG. 1 is shown four shaped layers. Each shaped layer showed in FIG. 1 has a different phase level, which here is Δφ=0, Δφ=π/2, Δπ=π and Δφ=3π/2 obtained by overlaying two deposition layers 25 (see FIG. 7) of patterned TiO₂ films of thickness t=h₁ and t=h₂, respectively, by conformal deposition (here Atomic Layer Deposition, ALD) on the surface of the optically transparent substrate, pre-patterned with a homogenous nano-hole array (hole depth h, hole diameter d, hole array period p). The surface 26 is thereby divided into areas each with TiO₂ film thickness t being 0, h₁, h₂, or h₁+h₂, with corresponding different optical phase modulation Δφ.

The diameter d of the nano-holes and the period p of the nano-hole array is sub-wavelength, here p=200 nm, while the size of the TiO₂ film pattern elements is 500 nm to 10 mm. The patterned TiO₂ film is manufactured by two consecutive photolithography processes: UV-lithography, conformal deposition of TiO₂ (thickness h₁), lift-off, UV-lithography (with overlay registration to first TiO₂ pattern), conformal deposition of TiO₂ (thickness h₂), lift-off.

The process has been demonstrated to fabricate four phase level phase modulation Fresnel lenses and gratings.

The process has wider/general applications for diffractive optical elements, including optical gratings, phase-masks and holograms. The surface is divided into pixels of side length down to 1 micrometer (limited by applied UV lithography), and each pixel is assigned one of four available phase levels (specific value given by nano-hole geometry and TiO₂ film thickness).

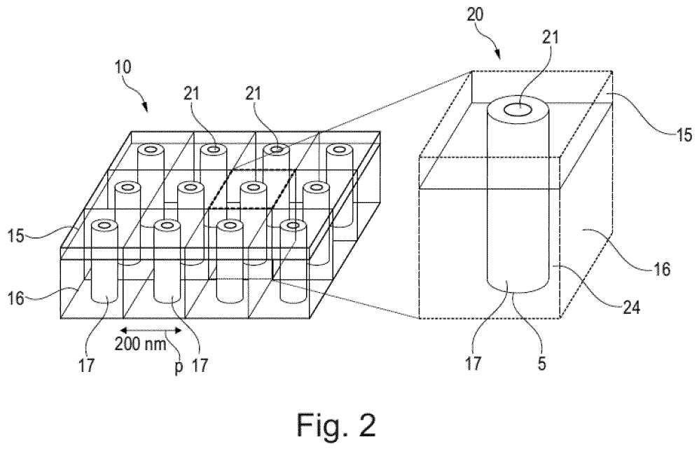

FIG. 2 outlines the truncated waveguide metasurface architecture and a meta-atom used in the invention.

FIG. 2 (left) shows a metasurface 10 comprising a transparent dielectric material 15 on a transparent substrate 16. In the transparent substrate are nano-holes 17, the transparent substrate is covered by the transparent dielectric material 15, which are also coving the nano-holes 17 and are deposited at the bottom 5 of the nano-holes and at the side walls 24 of the nano-holes and leaves a nano-tube 21 in the centre of the nano-hole.

FIG. 2 (right) illustrates a meta-atom 20, which is a part of the metasurface comprising only one nano-hole or one nano-pillar, which may be covered by the transparent dielectric material 15 leaving a nano-tube 21.

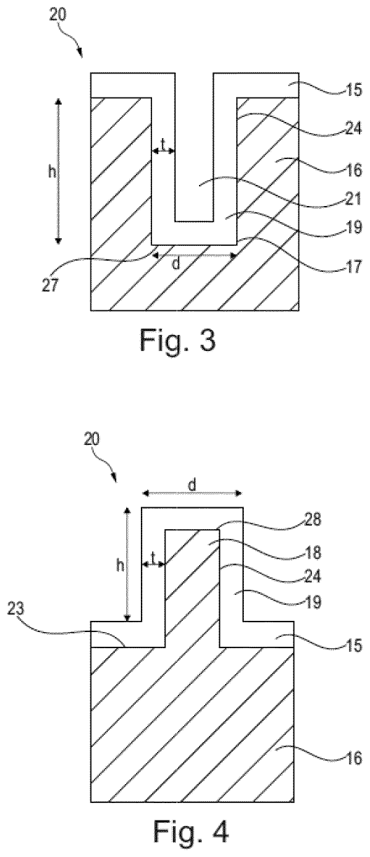

FIG. 3 shows a cross-section of a meta-atom 20 comprising a substrate 16 covered by a dielectric material 15. A nanotube 21 is formed in the nano-hole 17 of the substrate 16 when the dielectric material 15 is deposited on the substrate 16.

A transparent dielectric substrate 16 of moderate refractive index—here exemplified by fused silica of refractive index n ~1.46—fitted with an array of identical nano-holes 17 of with nano-hole diameter d ~150 nm, nano-hole depth h ~500 nm and array period p ~200 nm. Truncated waveguide meta-atoms 14 are formed by conformal deposition of dielectric material 15, which preferable may be TiO₂ (refractive index n ~2.7) of thickness t. For given nano-hole array dimensions, diameter d, height h, the phase-change of transmitted light is controlled by thickness t of deposited material, i.e. the nano-tube wall thickness.

FIG. 4 shows a cross-section of a meta-atom 20 comprising a substrate 16 covered by a dielectric material 15. A dielectric cylinder 19 is formed on the nano-pillar 18 of the substrate 16, when the dielectric material 15 is deposited on the substrate 16.

The nano-pillar depth preferably will be about h ~500 nm The pillar diameters d would be 300 nm or less, and pillar centre-to-centre distance, the period p, would be 100-400 nm, such as 200 nm; obviously observing that the pillar diameter should be smaller than the centre-to-centre distance.

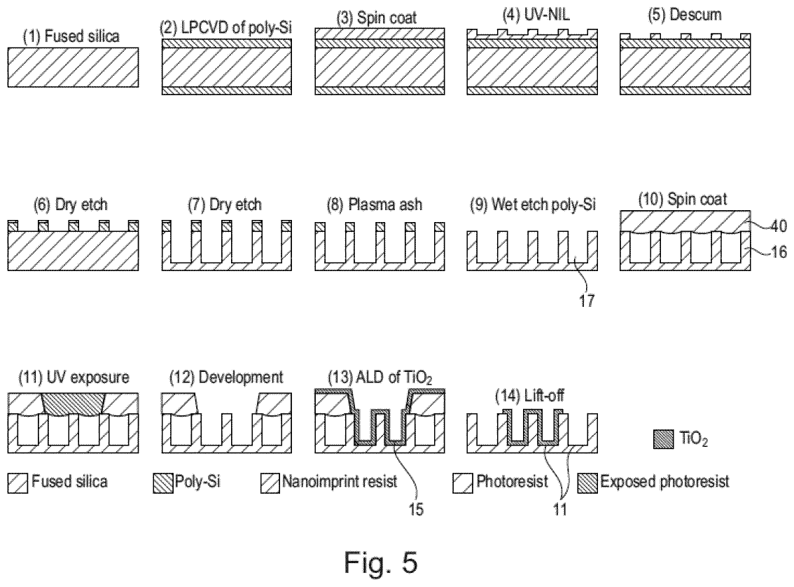

FIG. 5 shows an outline of process flow for cost-efficient fabrication of individualized optical Metasurfaces 10 by UV lithography on nanostructured substrates 16. Each panel shows the cross section of the metasurface component at different steps in the process flow. Panel (1)-(9): Fabrication of transparent, dielectric substrate 16 with an array of identical nano-holes 17 using nanoimprint lithography (NIL). Panel (10)-(14) deposition of transparent dielectric material 15 in the form of a patterned film of TiO₂ to define metasurface 10 with two different shaped layers 11.

A metasurface 10 encoded with multiple shaped layers 11 corresponding to different phase-levels are defined by depositing transparent dielectric material 15, preferable TiO₂, in a pattern as outlined in FIG. 5. The TiO₂ deposition is controlled selectively by masking the metasurface 10 with a photoresist 40, which is known as a lift-off process. In this way, two shaped levels 11 can be achieved, i.e., one level with TiO₂ and another without, which results in a phase difference between the two shaped levels.

The spin coated photoresist 40—step 10 in FIG. 5—is exposed with UV-light—step 11 in FIG. 5—using a mask less aligner for UV-lithography—for instance MLA150 Mask less Aligner from Heidelberg Instruments—, which has a practical resolution limit of 1 μm. Thus, 6 cm diameter meta-lenses with focusing powers of up to 9 Dioptre can be manufactured using this technique. The exposed part of the photoresist 40 is dissolvable using a chemical developer—for instance AZ® 726 MIF from Microchemical. Therefore, the nanostructured fused silica surface of the transparent substrate 16 can be selectively covered with unremoved photoresist 40. The dielectric material 15 is deposited—step 13 in FIG. 5—preferably using Atomic Layer Deposition (ALD).

This conformal deposition method covers all exposed surfaces with a uniform layer of TiO₂. The unexposed photoresist 40 can then be removed in an acetone solution, assisted by ultrasound—step 14 in FIG. 5. This process dissolves the photoresist 40, which is removed from the fused silica nanostructures of the transparent substrate 16 together with TiO₂ on top of the photoresist, known as a lift-off process. Therefore, the TiO₂ remains on the fused silica nanostructures of the transparent substrate 16, which were not covered by photoresist. In this way, the shape layers 11 can be made. This allows for fast production of large area optical metasurfaces, at the cost of only two phase levels. Multiple phase levels can be produced with succeeding lift-off processes. A four phase level optical metasurface can be fabricated by two consecutive lift-off processes.

The steps is illustrated in FIG. 5:

Step 1: The selected transparent substrate is a fused silica.

Step 2: A layer of poly-Si is deposited on the substrate using a low-pressure chemical vapour deposition (LPCVD) technique.

Step 3: A spin coat procedure is used to deposit a UV-nanoimprint resist layer on the poly-Si.

Step 4: Using ultraviolet nanoimprint lithography some of the spin coat UV-nanoimprint resist is removed where the nano-holes 17 are to be made.

Step 5: By a descum method further UV-nanoimprint resist is removed.

Step 6: Using dry etch poly-Si is removed where the nano-holes 17 are to be made.

Step 7: By using further dry etch method, the nano-holes 17 are made in the substrate.

Step 8: Remaining UV-nanoimprint resist is removed by plasma ashing.

Step 9: Remaining poly-Si is removed by a wet etching process.

Step 10: Photoresist 40 is deposited on the substrate.

Step 11 and 12: By UV exposure and development, the photoresist is removed where transparent dielectric material 15 is to be deposed on the substrate.

Step 13: TiO₂ is deposited on the photoresist and the substrate.

Step 14: By lift-off process the photoresist and the TiO₂ on top of the photoresist is removed leaving the substrate with the deposited TiO₂.

The steps 10-14 may be repeated to create deposition layers of TiO₂ of different thickness creating more phase levels.

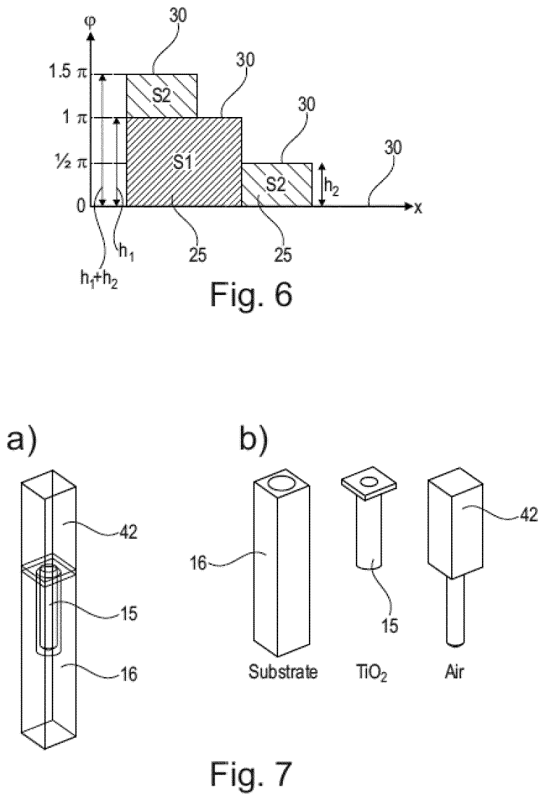

FIG. 6 shows a two-step UV lithography lift-off process, where the first deposition (S1) step provides 1 π phase shift, whereas the second step (S2) provides π/2 phase shift and a 1.5 π phase shift when added to S1.

A metasurface with four phase levels 30, can be fabricated by overlaying two UV lithography and lift-off process steps, as illustrated in FIG. 6. The first step (S1) consists of depositing a deposition layer 25 of TiO₂ with thickness h₁ that provides π phase shift, while the second step (S2) deposit a deposition layer 25 of TiO₂ with thickness h₂ that provides π/2 phase shift. In addition, when the S2 overlaps with S1, 1.5 π phase can be obtained by obtaining a TiO₂ thickness h₁+h₂. In total, four phase levels of 0, ½, 1 and 1.5 φ phase shift is obtained through this two-step lift-off process. Each phase level corresponds to shaped layers of the same thickness. For each phase level, there may by several shaped layers of the same thickness. We estimate that a meta-lens with such a phase profile will have about 70-80% diffraction efficiency. Initial tests have verified that the MLA150 Mask less Aligner from Heidelberg Instruments in DTU Nanolab can provide the required overlay accuracy.

A phase shift of 1π radians correspond to a rotation of 180 degrees in a complex plane. In a wave or signal, a phase shift of 1π means that the wave or signal has been delayed by half a period, or 180 degrees out of phase. In other words, the peak of the wave or signal has been shifted by half a period.

FIG. 7 shows an illustration of numerical simulations for metasurfaces design. FIG. 7 (a) shows the full geometry of the model. FIG. 7 (b) shows the individual parts/materials in the model, the substrate 16 the dielectric material 15 and air 42.

In order to realize a metasurface 10 with a specific phase profile Δφ(x, y); a COMSOL (finite element simulation) model has been developed. The model solves a plane wave propagating through the metasurfaces for desired wavelengths and allows fast calculation of the transmittance, absorptance and S-parameters (from which the phase change can be determined) for a given meta unit cell. The model can be seen in FIG. 7. The model also allows investigation of the field intensity and stored energy at certain resonant modes, which may be used when the metasurfaces are applied for optical sensing.

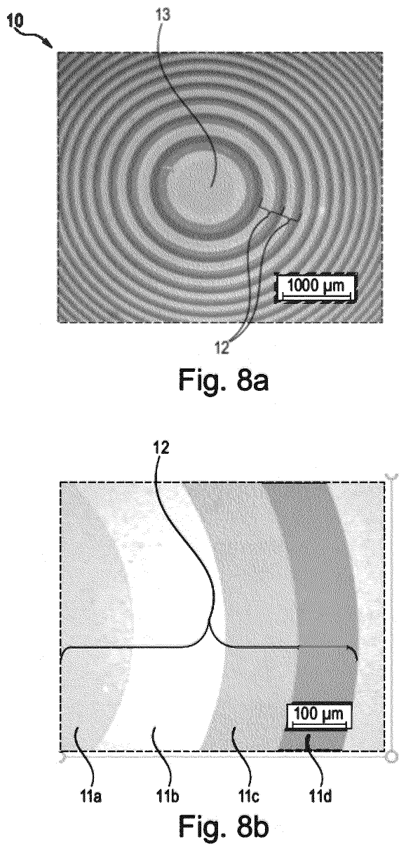

FIG. 8a shows an optical metasurface 10 according to the invention. The optical metasurface forms a Fresnel metasurface meta-lens. The metasurface comprises a plurality of ring formed shape layers 11 forming the Meta lens corresponding to a Fresnel lens; Four ring formed shaped layers are forming a Fresnel ring 12. Each Fresnel ring may comprise four ring formed shape layers 11a, 11b, 11c, and 11d. FIG. 8b is an enlarged section of FIG. 8a showing part if the four ring formed shape layers 11a, 11b, 11c, and 11d, which is forming one Fresnel ring. The innermost ring formed shape layer is covering the centre 13 and the innermost ring formed shape layer therefore is formed as a disc, while all other ring formed shape layer are open in the centre.

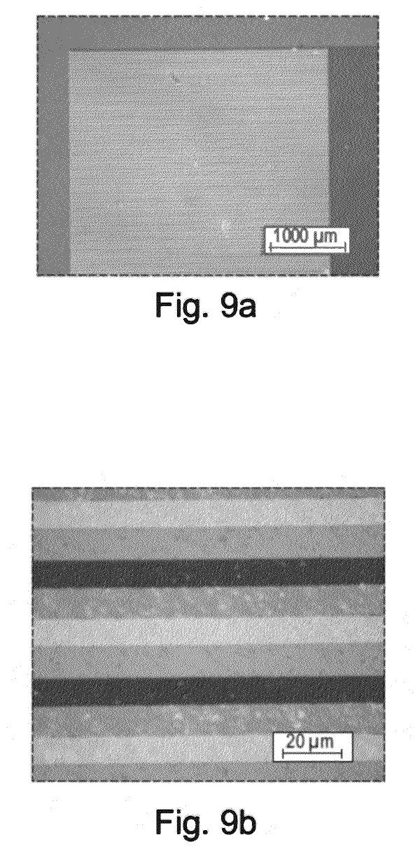

FIG. 9a shows another optical metasurface 10 according to the invention. The metasurface comprises shaped layers of four different thicknesses forming a 4-level blazed grating, thereby the blaze grating comprises four phase levels. Here the shaped layers are substantially linear. FIG. 9b is in enlarged image of a section of FIG. 9a showing the shaped layers of four different thicknesses.

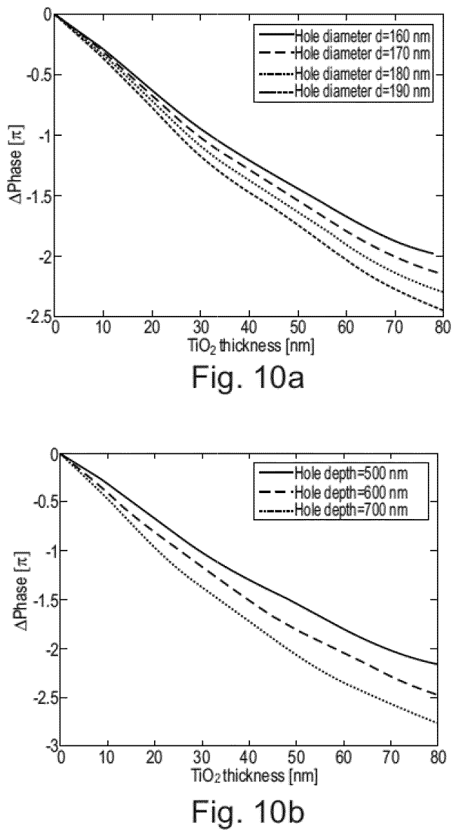

FIG. 10a shows a simulated phase shift as a function of the TiO₂ thickness t of the dielectric material 15, for different nano-hole diameters d, for the metasurface geometry: h=500 nm and p=200 nm. As the diameter increases, the available phase span also increases.

From Comsol simulations, the phase shift Δφ, of transmitted light, measured relative to the bare nanostructured substrate, i.e. TiO₂ thickness t=0, is extracted. In FIG. 10a the influence of nano-hole diameter d and TiO₂ thickness t is evaluated for a metasurface of period p=200 nm and nano-hole depth h=500 nm.

As seen from FIG. 10a, the phase shift Δφ increases with TiO₂ thickness t of the dielectric material 15. It is also observed that larger nano-hole diameter d provides a larger phase shift when the TiO₂ thickness is changed. Therefore, it is favourable to increase the nano-hole diameter as much as possible. It is however important to keep the diameter d below the period of p=200 nm, else the nano-holes begin to merge, which would result in shallower nano-holes (smaller h), or in the worst case completely ruin the unit cell structure.

FIG. 10b shows a simulated phase shift as a function of the TiO₂ thickness t of the dielectric material 15, for different nano-hole depths h, for the geometry: d=180 nm and p=200 nm. As the nano-holes penetrate deeper into the substrate, the phase span increases. A depth of 500 nm is necessary to span a 2π phase space.

The influence nano-hole depth h was investigated by Comsol simulations, for a metasurface with d=180 nm and p=200 nm. Three different nano-hole depths were chosen: h=[500, 600, 700] nm. The results of these simulations are shown in FIG. 10b. First, it is noted that a minimum nano-hole depth of h ~500 nm is required to span a Δφ=2π phase shift range before the nano-holes are filled with TiO₂ (d=p).

Secondly, as the depth of the nano-holes increases, a higher phase shift is expected when the TiO₂ thickness t is changed. The specified nano-hole depth of 500 nm does span a 2π phase space, but a deeper nano-hole depth is preferred. Obviously, there will be limits to how deep the nano-holes can be fabricated, and a value of 500 nm might already be close to the limit.

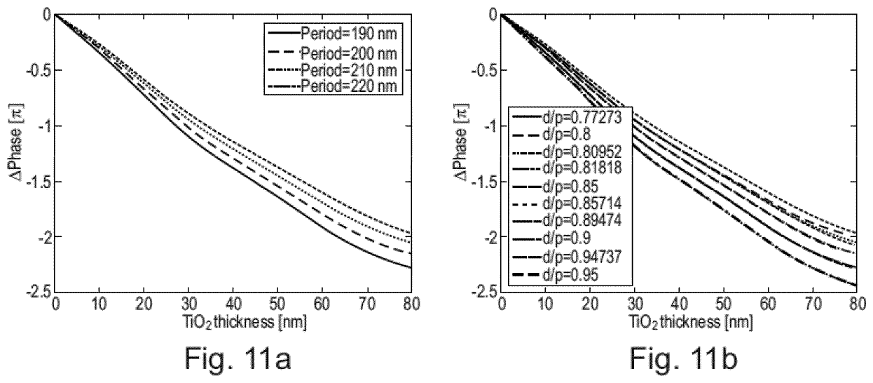

FIG. 11a shows simulated phase shift as a function of the TiO₂ thickness of the dielectric material 15 for different periods, for the geometry: h=500 nm and d=170 nm. A penalty in the phase span is observed with increasing period. (Right) Simulated phase shift as a function of the TiO₂ thickness for different ratios of the diameter and periods, for combinations of d=[160, 170, 180, 190], p=[190, 200, 210, 220] nm and h=500. It can be observed that d/p is an important design parameter that should be maximised.

The influence of period p is investigated. Four periods were chosen: p=[190, 200, 210, 220] nm. The results of these simulations are shown in FIG. 11a. From this, note that a decrease in the period seems preferable. This could follow from the same trend as with an increase in diameter so that the figure of merit to maximize is the ratio of the nano-hole diameter to the period, i.e. d/p. This is shown in FIG. 11b. Thus, if the period is changed from the standard geometry, the nano-hole diameter should follow and in general, a higher d/p ratio is preferred. Note, however, that increasing the d/p ratio by minimizing the period could limit the maximum possible TiO₂ thickness.

Further Comsol simulations indicate that the obtained phase shifts have little or negligible dependence on the dielectric substrate refractive index for values 1.4-1.5.

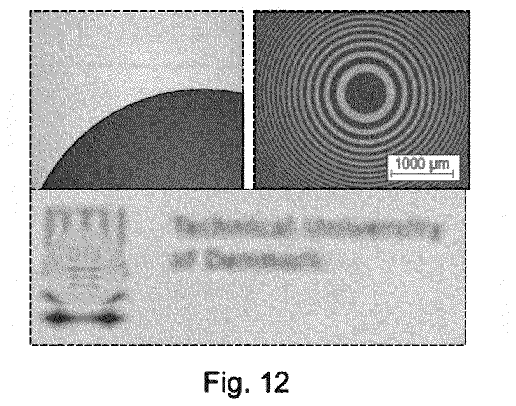

FIG. 12 shows (Top left) a microscope image of 8 mm diameter diopter 15 binary phase Fresnel metasurface meta-lens. (Top right) Microscope image of 8 mm diameter diopter 2.5 binary phase Fresnel metasurface meta-lens. (Bottom) Diopter 15 lens focuses DTU logo.

A prototype lens has been demonstrated, see FIG. 12. The lens is a binary phase Fresnel zone lens, with a lens diameter of 8 mm and a phase modulation Δφ~π.

Two lenses have been fabricated, a diopter 2.5 (40 cm focal length) and diopter 15 (6.7 cm focal length). The diffraction efficiency was estimated to 41% for the diopter 15 lens, close to the theoretical maximum (40.5%) for binary phase lenses.

The meta-lenses comprises ring formed shaped layers, generally the ring formed shaped layers are wider close to the centre and smaller further away from the centre.

Required lithographical resolution for Fresnel zone plate lenses with N phase levels:

The demonstrated meta-lenses are designed as phase modulation Fresnel zone plates. The ring formed shaped layers have radii In:

$${r}_{n}^{2} = n λ f + \frac{1}{4} {n}^{2} {λ}^{2}$$

Where n=1, 2, . . . is the layer number, λ the wavelength of the incoming light, and f the focal length.

The focal length is the distance between the lens and the point where the light converges to a single point.

For a (two phase level) lens of diameter Dₗ, the thinnest, outermost layer has the width:

$$Δ {r}_{min} = \frac{{λ}_{0} f}{{D}_{l}}$$

For a lens diameter Dₗ=4 cm, the smallest feature size Armin needed to write a f=8.33 cm lens (diopter 12) with two phase levels will be 1.1 μm (using λ=532 nm).

Correspondingly, a lens with N=3, 4, . . . phase levels will require lithography resolution (minimum line width)

$$Δ {r}_{min} = \frac{{λ}_{0} f}{N {D}_{l}}$$

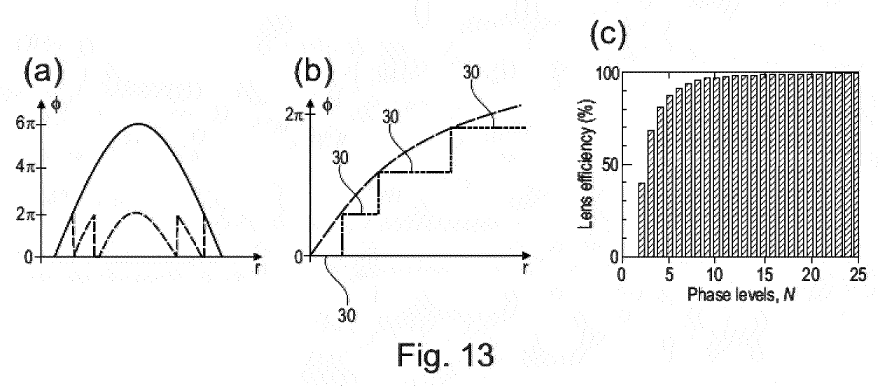

FIG. 13 shows a phase lens design. FIG. 13 (a) shows the required phase modulation profile for the meta-lens (solid curve) is wrapped to 2π (dashed curve) forming concentric “Fresnel Zones”, where the phase evolves between 0 and 2 π. FIG. 13 (b) shows phase discretization: To fabricate the meta-lens, 0-2 π phase modulation in each zone (smooth curve) is discretized into N phase levels (dashed step-like curve). FIG. 13 (c) shows theoretical lens efficiency as function of phase discretisation levels, N.

The lens efficiency—i.e. the fraction power in focus to power of incoming light on the lens—can be significantly enhanced by increasing the number of phase levels 30. In a phase-modulation FZP lens, the required phase modulation profile for the lens is wrapped between 0 and 2π; see FIG. 13 (a). To fabricate the meta-lens, the 0-2π phase modulation is discretized into a number of phase levels, N, FIG. 13 (b). A binary phase meta-lens, with N=2 phase levels (0 and x) has a theoretical maximum efficiency of 40.5%. The meta-lens efficiency increases with increasing number of phase levels 30, as shown in FIG. 13 (c).

### Process on Fused Silica

### Sample Preparation

The process starts with the preparation of nanostructured fused silica substrate 16, where nanoimprinting technique was applied. The master stamp with silicon nano-holes was used, processed by electron beam patterning followed with silicon dry etching on a 4-inch silicon wafer. A daughter stamp of nano-pillars was fabricated with photoresist OrmoStamp through imprinting. Next, the daughter stamp was transferred through imprinting technique to a fused silica wafer, where the fused silica wafer had been pre-processed with LPCVD silicon deposition. The photoresist 40 used was mr-NIL200 and the nano-hole patterns of photoresist were built on top of the fused silica wafer. To develop the nano-hole structures on the fused silica wafer, O₂ plasma etching of the photoresist and reactive ion etching (RIE) of the silicon and silicon oxide were performed sequentially. Afterwards, the photoresist strip and the silicon strip by dry etching were performed to finish the preparation of the nanostructured fused silica substrate.

### Lift-Off Process

By using the above nanostructured fused silica substrate, large area UV lithography and lift-off patterning of TiO₂ were performed. For the first lithography, photoresist AZ5214E was spin coated on the 4-inch fused silica wafer with thickness of around 1.5 μm, followed by Maskless Aligner (MLA) writing with a dose of 70 mJ/cm² and developing with single puddle of 60 seconds. Next, a 66 nm TiO₂ ALD deposition was performed, where the deposition temperature was set to be 100° C. After the ALD deposition, lift-off in acetone ultrasonic bath was performed to remove the photoresist patterns and the TiO₂ on top of these photoresist patterns. The area without photoresist patterns (developed after mask UV writing) has TiO₂ directly deposited on the nano-holes, which allows the TiO₂ to remain after the lift-off process, producing the phase difference between neighbouring zones. The lift-off acetone bath temperature was about 30° C.

After the lift-off process, scanning electron microscope (SEM) was used to investigate the nano-hole structures on the fused silica wafer. For the second lithography and lift-off patterning, the processes were similar as the first time, but for the second time, a thickness of 33 nm TiO₂ was coated using ALD. Therefore, by combining the 1^{st} 66 nm TiO₂, there would be 4-level TiO₂ thickness of 0 nm, 33 nm, 66 nm, and 99 nm, where the 99 nm is a superposition of two times' TiO₂ deposition.

SEM Images after the Lift-Off

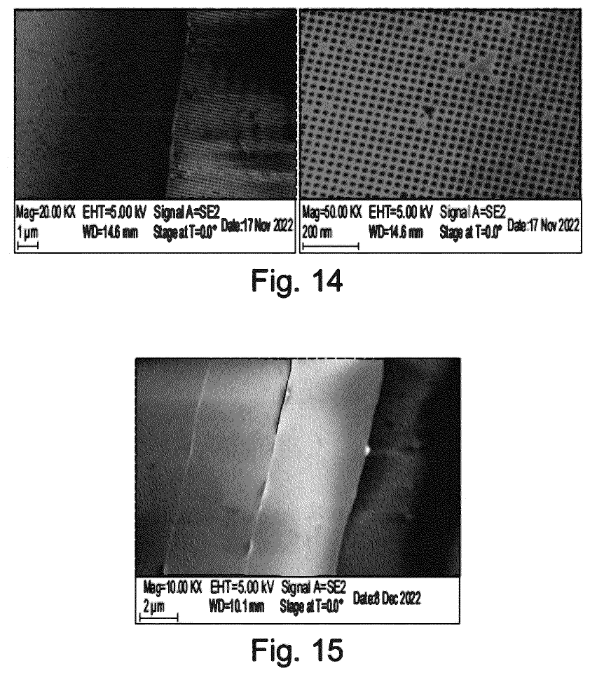

FIG. 14 shows SEM images of the first lift-off process on fused silica substrate. After the first lift-off process, SEM was employed to check the nano-hole structures, see FIG. 14. The SEM images show the nano-holes were retained after lift-off process. The left scan on FIG. 14 shows the intersection between the nano-holes with and without the TiO₂ deposition. The left side shows the nano-holes covered with 66 nm TiO₂, with nano-holes of smaller size than the non-covered (right side). This TiO₂ covering will provide the phase retardation.

FIG. 15 shows a SEM image of the second lift-off process on fused silica substrate.

SEM image of second lift-off process is shown in FIG. 15. The second process looks fine, and four phase levels corresponding to four TiO₂ thicknesses are clearly shown: 0, 33, 66 and 99 nm, both in term of colour and nano-hole size.

FIGS. 9a and 9b shows an optical microscope image of a 4-level Fresnel lens. Similar to the SEM scans, four distinct levels are observed, corresponding to the four TiO₂ thicknesses of 0, 33, 66 and 99 nm.

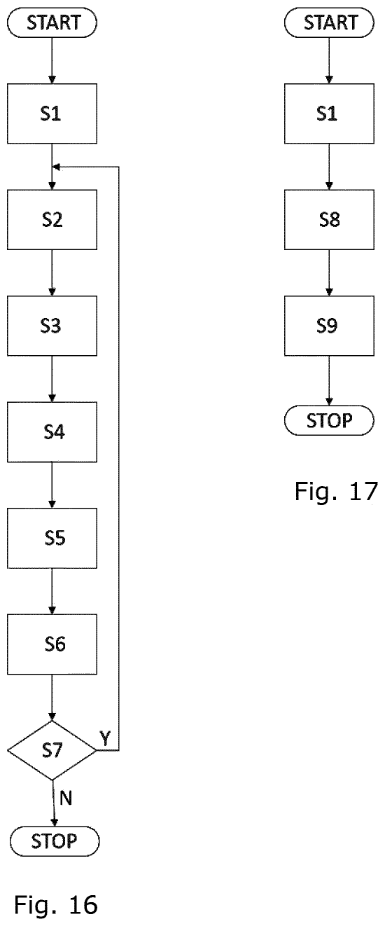

FIG. 16 is a flow chart illustrating the main method of the invention. First the method is providing in step S1 a transparent substrate comprising a plurality of nano-holes or nano-pillars. Then covering in step S2 the transparent substrate 16 and/or previous deposited transparent dielectric material 15 by a layer of photoresist 40. In step S3 exposing the photoresist with electromagnetic radiation, where the transparent dielectric material is to be placed in contact with the transparent substrate or the previous deposited transparent dielectric material, or where the transparent dielectric material is not to be placed in contact with the transparent substrate or the previous deposited transparent dielectric material. In step S4 removing either the photoresist, which has been exposed to electromagnetic radiation, or the photoresist, which has not been exposed to electromagnetic radiation. In step S5 covering at least a portion of the substrate 15 and/or the previous deposited transparent dielectric material 16 with a deposition layer 25 of transparent dielectric material. In step S6 removing the remaining photoresist 40 and hereby also removing transparent dielectric material deposited on the top of the photoresist. The steps S2-S6 may be repeated a predetermined number of times. If repeating the steps S2-S6 then the method goes to step S2, if no more repetitions, then the method is completed.

FIG. 17 is a flow chart illustrating an alternative method of the invention. First the method is providing in step S1 a transparent substrate comprising a plurality of nano-holes or nano-pillars. Then in step S8 the method is covering at least a portion of the transparent substrate 16 with transparent dielectric material 15, and then in step S9 the method is geometrically modifying the transparent dielectric material 15 on the transparent substrate 16 by removing portions of the transparent dielectric material (15) to form the shaped layers (11).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An optical metasurface to interact with incoming light, wherein the metasurface is comprising
a transparent substrate comprising a plurality of nano-holes or nano-pillars, wherein the nano-holes or nano-pillars have vertical or substantially vertical side walls extending perpendicular to a base plane of the substrate, and
a plurality of shaped layers comprising a transparent dielectric material, wherein each shaped layer covers a plurality of the nano-holes or the nano-pillars of the transparent substrate.

2. The optical metasurface according to claim 1, wherein the distance between two neighbouring nano-holes or nano-pillars is less than half the wavelength of the incoming light, where the incoming light can be ultra-violet light, visible light, near infrared light and/or infrared light.

3. The optical metasurface according to claim 1, wherein the optical metasurface is a truncated waveguide metasurface comprising a two-dimensional array of meta-atoms, where each meta-atom comprises one nano-hole or nano-pillar.

4. The optical metasurface according to claim 1, wherein two neighbouring shaped layers are of a different thickness, which results in a different phase shift of the incoming light.

5. The optical metasurface according to claim 1, wherein the nano-holes or nano-pillars comprises a sidewall and a bottom or top, and the transparent dielectric material is deposited on the sidewalls and on the bottom or top, forming a dielectric cylinder.

6. The optical metasurface according to claim 1, wherein the plurality of shaped layers are ring shaped, and each shaped layer is uninterrupted along the ring shape.

7. The optical metasurface according to claim 6, wherein the optical metasurface comprises a plurality of Fresnel rings forming a Fresnel metasurface meta-lens, each Fresnel ring comprises two, or more, shaped layers with different thickness.

8. The optical metasurface according to claim 1, wherein the plurality of shaped layers are forming a concentric annular closed loop, preferable a circle or an ellipse.

9. The optical metasurface according to claim 1, wherein the transparent dielectric material is a high index dielectric material, which has been selected from a list of TiO₂, Al₂O₃, Si, SiO₂, Ge, GaAs, InP, HfO₂, BaTiO₃, Pb[ZrₓTi₁₋ₓ]O₃, SrTiO₃, Ba₍₁₋ₓ₎SrₓTiO₃, PbTiO₃, CaTiO₃, MgO, ZrO₂.

10. An optical device comprising the metasurface according to claim 1, wherein the optical device has been selected from a list of a meta-lens, a blazed grating, a phase plate, a hologram, a vortex beam generator, a spatial light modulator, an optical switch.

11. A pair of spectacles comprising at least one meta-surface according to claim 1, wherein the shaped layers are ring shaped.

12. A method for producing an optical metasurface for interacting with incoming light, wherein the method is comprising:
providing a transparent substrate comprising a plurality of nano-holes or nano-pillars, wherein the nano-holes or nano-pillars have vertical or substantially vertical side walls extending perpendicular to a base plane of the transparent substrate, and
covering at least a portion of the transparent substrate with shaped layers of a transparent dielectric material so that each shaped layer covers a plurality of the nano-holes or nano-pillars of the transparent substrate.

13. The method according to claim 12, wherein covering at least a portion of the transparent substrate with shaped layers of a transparent dielectric material comprises the steps:
a) covering the transparent substrate and/or previous deposited transparent dielectric material by a layer of photoresist,
b) exposing the photoresist with electromagnetic radiation, where the transparent dielectric material is to be placed in contact with the transparent substrate or the previous deposited transparent dielectric material, or where the transparent dielectric material is not to be placed in contact with the transparent substrate or the previous deposited transparent dielectric material,
c) removing either the photoresist, which has been exposed to electromagnetic radiation, or the photoresist, which has not been exposed to electromagnetic radiation,
d) covering at least a portion of the substrate and/or the previous deposited transparent dielectric material with a deposition layer of transparent dielectric material,
e) removing the remaining photoresist and hereby also removing transparent dielectric material deposited on the top of the photoresist, and
f) repeating the steps a)-e) a predetermined number of times.

14. The method according to claim 12, wherein covering at least a portion of the transparent substrate with shaped layers of a transparent dielectric material comprises the steps:
covering at least a portion of the transparent substrate with transparent dielectric material, and
geometrically modifying the transparent dielectric material on the transparent substrate by removing portions of the transparent dielectric material to form the shaped layers.

15. The method according to claim 12, wherein the method further comprises
removing portions of the layer of the transparent dielectric material by laser ablation.
